(19) United States
(12) Patent Application Publication
(10) Pub. No.: US 2018/0081634 A1
(43) Pub. Date: Mar. 22, 2018

(54) PIECEWISE POLYNOMIAL EVALUATION INSTRUCTION

(71) Applicant: QUALCOMM Incorporated, San Diego, CA (US)

(72) Inventors: Eric Mahurin, Austin, TX (US); David Hoyle, Austin, TX (US)

(21) Appl. No.: 15/273,481

(22) Filed: Sep. 22, 2016

(51) Int. Cl. G06F 7/544; G06F 7/57; G06F 9/30

(52) U.S. Cl. CPC G06F 7/544; G06F 9/3001; G06F 7/57

(57) ABSTRACT

A method includes retrieving, at a processor, a first instruction for performing a first piecewise Horner's method operation for a polynomial and executing the first instruction. Executing the first instruction causes the processor to perform operations including accessing one or more look-up tables based on an interval of a first function input to determine a first coefficient of the polynomial for the first input range. The operations also include determining a first partial polynomial output of the first piecewise Horner's method operation. Determining the first partial polynomial output includes multiplying a first partial polynomial input with the first function input to generate a first partial value and adding the first coefficient to the first partial value to determine the first partial polynomial output.

### I. FIELD

The present disclosure is generally related to an instruction for evaluating a nonlinear function.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), tablet computers, and paging devices that are small, lightweight, and easily carried by users. Many such computing devices include other devices that are incorporated therein. For example, a wireless telephone can also include a digital still camera, a digital video camera, a digital recorder, and an audio file player. Also, such computing devices can process executable instructions, including software applications, such as a web browser application that can be used to access the Internet and multimedia applications that utilize a still or video camera and provide multimedia playback functionality.

A wireless device may include a processor that is operable to evaluate nonlinear functions. A variety of different applications may be processed using nonlinear functions. Non-limiting examples of applications that may be processed using nonlinear functions include echo cancellation applications, image interpolation applications, radio communication applications, signal processing applications, etc. High-performance nonlinear processing may require a relatively large number of processing stages, which in turn, may result in relatively high power consumption and usage of a relatively large number of hardware components.

To illustrate, a processor may estimate a nonlinear function using a look-up table. For example, an instruction may be executable to cause the processor to look-up table entries to estimate (e.g., evaluate) the nonlinear function. However, the number of table entries used by the processor may be relative to the bit accuracy of the evaluated function. As a non-limiting example, the processor may look-up approximately one thousand table entries to estimate a value of a nonlinear function with up to ten bits of accuracy. The processor may undergo a relatively large number of processing stages to look-up one thousand table entries. Alternatively, the processor may estimate a nonlinear function by applying a polynomial of a finite input range. However, a bit accuracy of an evaluated function may be proportional to the order of the polynomial. Using a higher-order polynomial (e.g., a fourth order polynomial) compared to a lower-order polynomial (e.g., a second order polynomial) to achieve high bit accuracy for the evaluated function may result in a relatively large number of processing stages.

### III. SUMMARY

According to one implementation of the techniques disclosed herein, a method includes retrieving, at a processor, a first instruction for performing a first piecewise Horner's method operation for a first input range of a polynomial and executing the first instruction. Executing the first instruction causes the processor to perform operations including accessing one or more look-up tables based on an interval of a first function input corresponding to a first input range to determine a first coefficient of the polynomial for the first input range. The operations also include determining a first partial polynomial output of the first piecewise Horner's method operation for the first input range. Determining the first partial polynomial output includes multiplying a first partial polynomial input with the first function input to generate a first partial value and adding the first coefficient to the first partial value to determine the first partial polynomial output.

According to another implementation of the techniques disclosed herein, an apparatus includes a memory storing a first instruction for performing a first piecewise Horner's method operation for a polynomial. The apparatus also includes a data store storing one or more look-up tables. The one or more look-up tables include coefficient values for the polynomial at multiple input ranges. The apparatus further includes coefficient determination circuitry configured to access the one or more look-up tables based on an interval of a first function input corresponding to a first input range to determine a first coefficient of the polynomial for the first input range. The apparatus also includes computation circuitry configured to multiply a first partial polynomial input with the first function input to generate a first partial value. The computation circuitry is also configured to add the first coefficient to the first partial value to determine a first partial polynomial output of the first piecewise Horner's method operation for the first input range.

According to another implementation of the techniques disclosed herein, a non-transitory computer-readable medium includes a first instruction for performing a first piecewise Horner's method operation for a polynomial. The first instruction, when executed by a processor, causes the processor to perform operations including accessing one or more look-up tables based on an interval of a first function input corresponding to a first input range to determine a first coefficient of the polynomial for the first input range. The operations also include determining a first partial polynomial output of the first piecewise Horner's method operation for the first input range. Determining the first partial polynomial output includes multiplying a first partial polynomial input with the first function input to generate a first partial value and adding the first coefficient to the first partial value to determine the first partial polynomial output.

According to another implementation of the techniques disclosed herein, an apparatus includes means for storing a first instruction for performing a first piecewise Horner's method operation for a polynomial. The apparatus also includes means for storing one or more look-up tables. The one or more look-up tables include coefficient values for the polynomial. The apparatus also includes means for accessing the one or more look-up tables based on an interval of a first function input corresponding to a first input range to determine a first coefficient of the polynomial for the first input range. The apparatus also includes means for multiplying a first partial polynomial input with the first function input to generate a first partial value. The apparatus also includes means for adding the first coefficient to the first partial value to determine a first partial polynomial output of the first piecewise Horner's method operation.

### IV. BRIEF DESCRIPTION OF THE DRAWINGS

FIG. 1 is a diagram of a system that is operable to evaluate a nonlinear function using a piecewise polynomial evaluation instruction;

FIG. 2 illustrates a method for evaluating a nonlinear function using a piecewise polynomial evaluation instruction; and

FIG. 3 is a diagram of an electronic device that includes components operable to evaluate a nonlinear function using a piecewise polynomial evaluation instruction.

### V. DETAILED DESCRIPTION

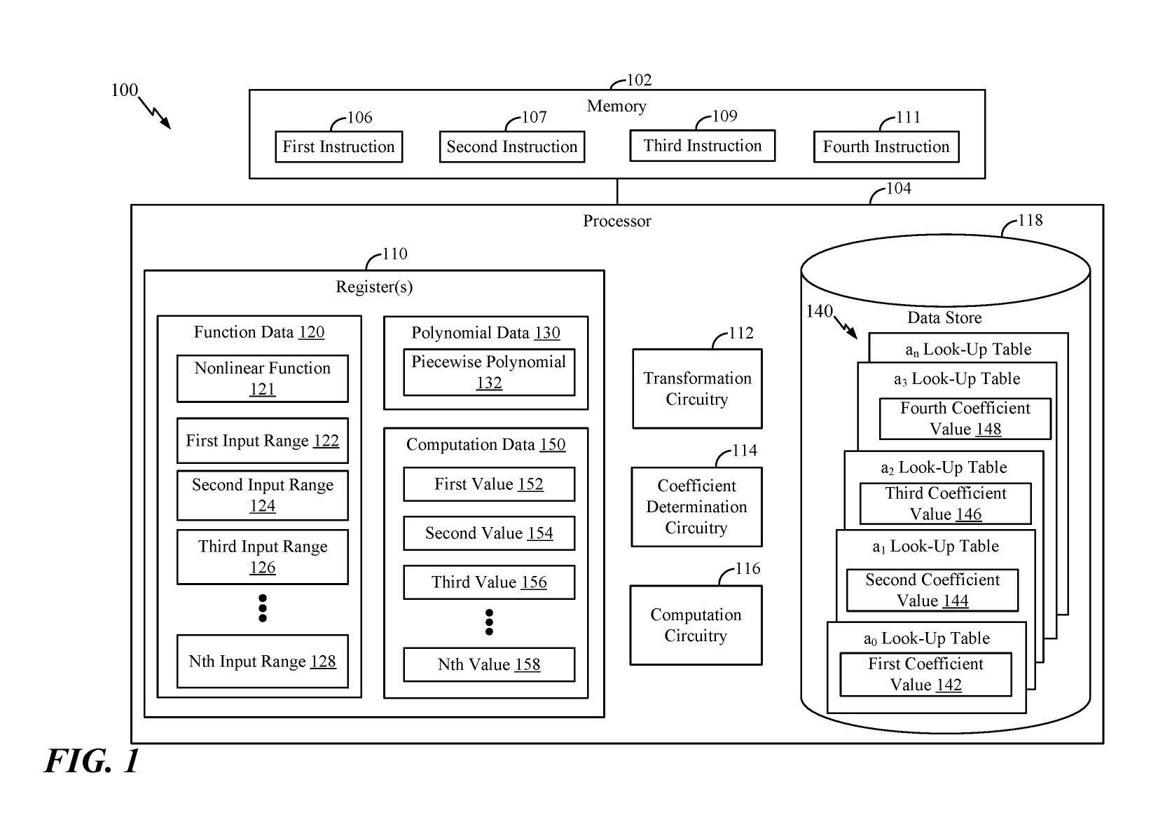

Referring to FIG. 1, a system 100 that is operable to evaluate a nonlinear function using a piecewise polynomial evaluation instruction is shown. The system 100 may be implemented within a mobile phone, a personal digital assistant (PDA), a computer, a laptop computer, a server, an entertainment unit, a navigation device, a music player, a video player, a digital video player, a digital video disc (DVD) player, or any other device.

The system 100 includes a memory 102 that is coupled to a processor 104. According to one implementation, the processor 104 may include a scalar processor. According to another implementation, the processor 104 may include a single-instruction-multiple-data (SIMD) processor. According to one implementation, the memory 102 may be a non-transitory computer-readable medium that includes instructions that are executable by the processor 104. For example, the memory 102 includes a first instruction 106, a second instruction 107, a third instruction 109, and a fourth instruction 111 that are executable by the processor 104 to perform piecewise Homer's method operations for a polynomial that may be used to approximate a nonlinear function for a particular input range.

The processor 104 includes one or more registers 110, transformation circuitry 112, coefficient determination circuitry 114, computation circuitry 116, and a data store 118 (e.g., a database). Although the data store 118 is shown to be included in the processor 104, in other implementations, the data store 118 may be separate from (and accessible to) the processor 104. Similarly, although the one or more registers 110 are shown to be included in the processor 104, in other implementations, the one or more registers 110 may be separate from (and accessible to) the processor 104. In other implementations, the processor 104 may include additional (or fewer) components. As a non-limiting example, in other implementations, the processor 104 may also include one or more arithmetic logic units (ALUs), one or more application-specific execution units, etc. Although the processor 104 is shown to include the transformation circuitry 112, the coefficient determination circuitry 114, and the computation circuitry 116, in other implementations, operations of each circuit component 112, 114, 116 may be performed by a single processing component.

The one or more registers 110 may store function data 120. The function data 120 includes a nonlinear function 121 to be evaluated by the processor 104. For example, the function data 120 and the nonlinear function 121 may be part of data that is provided to the processor 104 via an application associated with the nonlinear function 121. To illustrate, the nonlinear function 121 may be a polynomial, trigonometric, logarithmic, exponential, or other non-linear function that may be computationally expensive to evaluate accurately, such as due to a large amount of table entries for high-accuracy evaluation or due to evaluation of a high-order polynomial for accurately approximating the nonlinear function 121. The nonlinear function 121 may be approximated by a polynomial, expressed as p(x)=Σᵢ₌₀ⁿaᵢxⁱ=a₀+a₁x+a₂x²+a₃x³+ . . . +aₙxⁿ. According to the example, the polynomial p(x) includes n+1 coefficients (e.g., a₀, a₁, a₂, a₃, . . . , aₙ). However, to more accurately approximate the nonlinear function 121 using a lower-order polynomial, a piecewise polynomial may be used that includes multiple pieces corresponding to different intervals of (x) and may have different coefficients for each interval of (x). The accuracy of approximating the nonlinear function 121 may improve as the number of intervals of (x) increases. That is, greater bit accuracy may result from using a greater number of pieces of a piecewise polynomial approximation over different ranges of (x).

The processor 104 may be configured to use different intervals (e.g., input ranges) to evaluate the nonlinear function 121. The intervals may also be included in the function data 120. For example, the function data 120 includes a first input range 122 of the nonlinear function 121, a second input range 124 of the nonlinear function 121, a third input range 126 of the nonlinear function 121, and an Nth input range 128 of the nonlinear function 121. N may be any integer value that is greater than zero. For example, if N is equal to thirteen, the nonlinear function 121 may include thirteen different input ranges. As used herein, each input range 122-128 may correspond to a finite range for the variable (x) in the nonlinear function 121. Each input range 122-128 may be expressed using a particular number of bits. As a non-limiting example, each input range 122-128 may be expressed using sixteen bits.

For ease of illustration, the first input range 122 may include values of (x) between zero and one, the second input range 124 may include values of (x) between one and two, the third input range 126 may include values of (x) between two and three, and the Nth input range 128 may include values of (x) between three and four. It should be noted that the above examples are for illustrative purposes and should not be construed as limiting. In other examples, each input range may include values of (x) that span a shorter interval for greater bit accuracy during evaluation of the nonlinear function 121.

The processor 104 may be configured to retrieve the first instruction 106 from the memory 102. After retrieving the first instruction 106 from the memory 102, the processor 104 may be configured to execute the first instruction 106 to evaluate the nonlinear function 121. For example, the transformation circuitry 112 may be configured to retrieve the function data 120 from the one or more registers 110. Upon retrieving the function data 120, the transformation circuitry 112 may be configured to transform the nonlinear function 121 into a piecewise polynomial 132 having one or more coefficients. For example, the transformation circuitry 112 may apply a piecewise algorithm to the nonlinear function 121 to transform the nonlinear function 121 into the piecewise polynomial 132. According to one implementation, the piecewise algorithm is based on Horner's method. To illustrate, the piecewise polynomial 132 may be expressed as p(x)=a₀+x(a₁+x(a₂+x(a₃+ . . . +x(aₙ₋₁+aₙ)))). The piecewise polynomial 132 may also include the n+1 coefficients (e.g., a₀, a₁, a₂, a₃, . . . , aₙ) that are included in the nonlinear function 121.

Thus, transformation circuitry 112 may use Horner's method to transform the nonlinear function 121 (or an approximation of the nonlinear function 121) from a monomial form (e.g., p(x)=Σᵢ₌₀ⁿaᵢxⁱ=a₀+a₁x+a₂x²+a₃x³+ . . . +aₙxⁿ) into a computationally efficient form (e.g., p(x)=a₀+x(a₁+x(a₂+x(a₃+ . . . +x(aₙ₋₁+aₙx))))). The transformation circuitry 112 may generate polynomial data 130 that includes the piecewise polynomial 132. The polynomial data 130 may be stored in the one or more registers 110.

After the polynomial data 130 is generated, the coefficient determination circuitry 114 may be configured to determine values for the n+1 coefficients of the piecewise polynomial 132 by executing the instructions 106, 107, 109, 111. The data store 118 may include a look-up table 140 for each polynomial coefficient (a₀-aₙ). For example, the coefficient determination circuitry 114 may access one or more look-up tables 140 stored in the data store 118 to determine values for each of the n+1 coefficients of the piecewise polynomial 132 for a particular input range. For example, the one or more look-up tables 140 includes an a₀ look-up table, an a₁ look-up table, an a₂ look-up table, an a₃ look-up table, and an aₙ look-up table. Thus, each look-up table of the one or more look-up tables 140 is associated with a different coefficient of the one or more coefficients in the piecewise polynomial 132. Although the look-up tables 140 are shown to be stored in the data store 118, in other implementations, the look-up tables 140 may be stored in registers (e.g., the one or more registers 110). Upon determining the coefficient values (a₀-aₙ) for the particular input range, the processor 104 may apply the determined coefficients to the piecewise polynomial 132 for the particular input range to determine (e.g., evaluate) the nonlinear function at the particular input range (e.g., interval). For example, the processor 104 may insert the determined value for a₀ into the piecewise polynomial 132, insert the determined valued for a₁ into the piecewise polynomial 132, etc.

Table 1 illustrates a series of sequential operations that may be performed in an example where n=3 for the input range corresponding to the function input (x).

TABLE 1

| | | Partial | | | |
|---|---|---|---|---|---|
| Op. | LUT | Polynomial | Ftn. | Partial | Operation |
| Num. | Read | Input | Input | Value | Value |
| 1 | a₃ | 0 | x | 0 | a₃ |
| 2 | a₂ | a₃ | x | a₃x | a₂ + a₃x |
| 3 | a₁ | a₂ + a₃x | x | x(a₂ + a₃x) | a₁ + x(a₂ + a₃x) |
| 4 | a₀ | a₁ + x(a₂ + | x | x(a₁ + x(a₂ + | a₀ + x(a₁ + x(a₂ + |
| | | a₃x) | | a₃x)) | a₃x)) |

Each row of Table 1 illustrates processing during a corresponding operation of the piecewise Horner's method, with the first operation (Op. Num. 1) including a look-up table (LUT) read to retrieve coefficient a₃ from the data store 118 based on the input range for the function input (Ftn. Input) x, and generating a first value of a₃ for the first operation. A Partial Polynomial Input corresponds to the value of the prior operation (e.g., 0 for the first operation), a Partial Value indicates a multiplication operation of the Function Input with the Partial Polynomial Input, and the Operation Value indicates a result of adding the retrieved coefficient (e.g., a₃) to the Partial Value. The Operation Value may also be referred to as a “partial polynomial output.” The LUT Read and the multiplication operation may be performed in parallel, with the results added together to generate the operation value. Each of the operations 1-4 may be performed responsive to executing a corresponding one of the instructions 106, 107, 109, and 111, as described in further detail below.

To illustrate, upon executing the first instruction 106, the coefficient determination circuitry 114 may retrieve the function data 120 to determine the (a₃) coefficient for the first input range 122. The first input range 122 may be used as a table look-up indicator to determine the values for the (a₃) coefficient in the piecewise polynomial 132. For example, upon determining the first input range 122, the coefficient determination circuitry 114 may identify an interval or one or more bits (e.g., most significant bits (MSBs)) of the first input range 122 as a table look-up indicator. For example, a first function input (e.g., a binary number representing a value of (x)) corresponding to the first input range 122 may represent a value of (x) that is within the first input range 122, and the coefficient determination circuitry 114 may identify one or more MSBs of the first function input. The coefficient determination circuitry 114 may access the a₃ look-up table 140 using the one or more MSBs of the first function input to determine a first coefficient value 142 for the (a₃) coefficient in the piecewise polynomial 132 when (x) is in the first input range 122. For example, the coefficient determination circuitry 114 may determine that the (a₃) coefficient has the first coefficient value 142 for the first input range 122 based on a table look-up operation at the a₃ look-up table. The computation circuitry 122 may multiply a first partial polynomial input (e.g., zero during the first operation) with the first function input to generate a first partial value (e.g., zero). The computation circuitry 122 may also add the first coefficient value 142 to the first partial value to determine the first value 152 (e.g., a first partial polynomial output). Thus, the first value 152 may be equal to the first coefficient value 142. The computation circuitry 116 may store the first value 152 in the computation data 150 as the (a₃) coefficient for the next operation (e.g., the second operation to be performed in a second iteration) of the piecewise Horner's method.

After determining the (a₃) coefficient, the processor 104 may execute the second instruction 107 to determine the (a₂) coefficient for the first input range 122. The first input range 122 may be used as a table look-up indicator to determine the value for the (a₂) coefficient in the piecewise polynomial 132. The coefficient determination circuitry 114 may access the a₂ look-up table 140 using the one or more MSBs of the first input range 122 to determine a second coefficient value 144 for the (a₂) coefficient in the piecewise polynomial 132 when (x) is in the first input range 122. For example, the coefficient determination circuitry 114 may determine that the (a₂) coefficient has a second coefficient value 144 for the first input range 124 based on a table look-up operation at the a₂ look-up table. Upon determining the second coefficient value 144 for the first input range 122, the computation circuitry 116 may multiply a second partial polynomial input (e.g., a₃) with the first function input (x) to generate a second partial value of the piecewise polynomial 132 (e.g., a₃x). The second partial polynomial input (e.g., a₃) may correspond to the first value 152. The computation circuitry 116 may also add the first coefficient value 144 (e.g., the (a₂) coefficient) to the second partial value to generate a second value 154 (e.g., a₂+a₃x) of the second operation. The second value 154 (e.g., a second partial polynomial output) may be stored as computation data 150 for the next operation (e.g., the third operation to be performed in a third iteration) of the piecewise Horner's method.

After determining the (a₂) coefficient, the processor 104 may execute the third instruction 109 to determine the (a₁) coefficient for the first input range 122. The first input range 122 may be used as a table look-up indicator to determine the value for the (a₁) coefficient in the piecewise polynomial 132. The coefficient determination circuitry 114 may access the a₂ look-up table 140 using the one or more MSBs of the first input range 122 to determine a third coefficient value 146 for the (a₁) coefficient in the piecewise polynomial 132 when (x) is in the first input range 122. For example, the coefficient determination circuitry 114 may determine that the (a₁) coefficient has the third coefficient value 146 for the first input range 124 based on a table look-up operation at the a₁ look-up table. Upon determining the third coefficient value 146 for the first input range 122, the computation circuitry 116 may multiply a third partial polynomial input (e.g., a₂+a₃x) with the first function input (x) to generate a third partial value of the piecewise polynomial 132 (e.g., x(a₂+a₃x)). The third partial polynomial input may correspond to the second value 154. The computation circuitry 116 may also add the third coefficient value 156 to the third partial value to generate a third value 156 (e.g., a₁+x(a₂+a₃x)) of the third operation. The third value 156 (e.g., a third partial polynomial output) may be stored as computation data 150 for the next operation (e.g., the fourth operation to be performed in a fourth iteration) of the piecewise Horner's method.

After determining the (a₁) coefficient, the processor 104 may execute the fourth instruction 111 to determine the (α₀) coefficient for the first input range 122. The first input range 122 may be used as a table look-up indicator to determine the value for the (α₀) coefficient in the piecewise polynomial 132. The coefficient determination circuitry 114 may access the α₀ look-up table 140 using the one or more MSBs of the first input range 122 to determine a fourth coefficient value 148 for the (α₀) coefficient in the piecewise polynomial 132 when (x) is in the first input range 122. For example, the coefficient determination circuitry 114 may determine that the (α₀) coefficient has the fourth coefficient value 148 for the first input range 124 based on a table look-up operation at the α₀ look-up table. Upon determining the fourth coefficient value 148 for the first input range 122, the computation circuitry 116 may multiply a fourth partial polynomial input (e.g., a₁+x(a₂+a₃x)) with the first function input (x) to generate a fourth partial value of the piecewise polynomial 132 (e.g., x(a₁+x(a₂+a₃x))). The computation circuitry 116 may also add the fourth coefficient value 158 to the fourth partial value to generate a fourth value (e.g., a₀+x(a₁+x(a₂+a₃x))) of the fourth operation. The fourth value may be stored as computation data 150. Because N=3 in the present example, the method may end after the fourth operation, and the fourth value (e.g., a₀+x(a₁x(a₂+a₃x))) may be output as the estimated value of the nonlinear function 121 at the first function input (x).

Although the above example depicts operations where n=3 for the first input range 122, similar operations may be performed to determine additional coefficients of the piecewise polynomial 132 in implementations where n>3 for the first input range 122 to generate additional values up to an Nth value 158. The processor 104 may execute a different instruction to determine each coefficient. Additionally, the processor 104 may perform a multiply operation (e.g., multiply a partial polynomial input with a function input) associated with the determined coefficient and an add operation (e.g., add the result of the multiplication with a previous value of the piecewise polynomial 132) during execution of each instruction. After the last coefficient is determined for the first input range 122, the resulting value (after the multiply and add operation) may be the estimated value of the nonlinear function 121 for the first input range 122.

After determining the estimated value of the nonlinear function 121 for the first input range 122, the processor 104 may execute different instructions (according to a similar techniques as described above) to determine the estimated value of the nonlinear function 121 for the other input ranges 124, 126, 128. According to another implementation, processor 104 may use the techniques described above (with respect to estimating the value of the nonlinear function 121 for the first input range 122) to concurrently (or in parallel) estimate the values of the nonlinear function 121 for the other input ranges 124, 126, 128.

Thus, the system 100 of FIG. 1 may evaluate the nonlinear function 121 for each input range 122-128 by using look-up tables to determine coefficients (a₀-aₙ) for each input range 122-128 and applying the coefficients to the piecewise polynomial 132 (e.g., the nonlinear function 121 in a computationally efficient form). The system 100 may reduce the number of table entries used to evaluate a nonlinear function (e.g., the nonlinear function 121) compared to a conventional look-up method by using the instructions 106, 107, 109, 111 to access the look-up tables 140 to determine values for each coefficient (a₀-aₙ) as opposed to accessing look-up tables to predict the value of the nonlinear function 121 to within the same accuracy. As a result, the number of table entries used by the processor 104 may be reduced to a product of the number of coefficients present in the piecewise polynomial 132 and the number of input ranges (as opposed to a conventional technique where the number of table entries used by the processor may be relative to the bit accuracy of the evaluated function).

Additionally, the number of processing stages may be reduced compared to a conventional technique of applying a polynomial over an input range. For example, the first instruction 106 enables the processor 104 to perform an iteration of Horner's method to evaluate the nonlinear function 121, and a number of iterations (e.g., a number of multiply-add operations) may increase linearly with the order of the polynomial. Additionally, in some implementations, the look-up process may occur in parallel with the multiplication process (e.g., the computation operations associated with the computation circuitry 116) to reduce processing time. The reduction in processing stages may result in reduced power consumption and reduced complexity. The techniques described with respect to FIG. 1 are compatible with fixed-point numbers and floating-point numbers. The techniques are also compatible with scalar processing and SIMD processing.

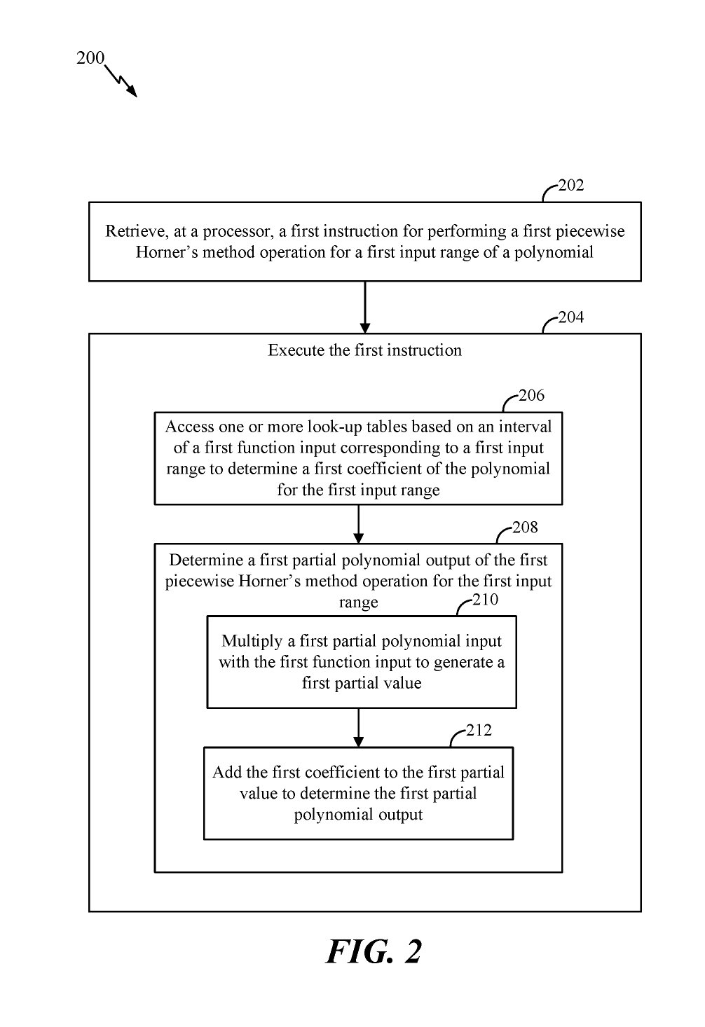

Referring to FIG. 2, a flowchart of a method 200 for performing a first piecewise Horner's method operation is shown. The method 200 may be performed using the system 100 of FIG. 1.

The method 200 includes retrieving, at a processor, a first instruction for performing a first piecewise Horner's method operation for a first input range of a polynomial, at 202. For example, referring to FIG. 1, the processor 104 may retrieve the first instruction 106 from the memory 102. The first instruction may be executed, at 204. For example, referring to FIG. 1, the processor 104 may execute the first instruction 106 to perform the first piecewise Horner's method operation for the first input range of the polynomial.

Executing the first instruction includes accessing one or more look-up tables based on an interval of a first function input corresponding to a first input range to determine a first coefficient of the polynomial for the first input range, at 206. For example, the first input range may have a fixed power-of-two size, and the interval may be based on one or more MSBs of the input function. To illustrate, referring to FIG. 1, a first function input (e.g., a binary number (x)) corresponding to the first input range 122 may have MSBs that represent the first input range 122, and the coefficient determination circuitry 114 may identify one or more MSBs of the first function input. The coefficient determination circuitry 114 may access a look-up table, such as the a₃ look-up table 140 using the one or more MSBs of the first function input to determine a first coefficient value 142 for the (a₃) coefficient in the piecewise polynomial 132 when (x) is in the first input range 122. For example, the coefficient determination circuitry 114 may determine that the (a₃) coefficient has the first coefficient value 142 for the first input range 122 based on a table look-up operation at the a₃ look-up table. As another example, the first input range may have an exponential size, and the interval may be determined at least partially based on a logarithm of the first function input. To illustrate, for fixed point, a leading zero or leading sign count corresponds to a bias from −ceil(log 2(value)), and for floating-point, the exponent field is biased from ceil(log 2(value)).

Executing the first instruction also includes determining a first partial polynomial output of the first piecewise Horner's method operation for the first input range, at 208. Determining the first partial polynomial output includes multiplying a first partial polynomial input with the first function input to generate a first partial value, at 210. For example, referring to FIG. 1, the computation circuitry 116 may multiply a first partial polynomial input (e.g., zero for the first iteration) with the first function input to generate the first partial value. According to one implementation, the first function input is normalized to the first input range. The method 200 also includes adding the first coefficient to the first partial value to determine the first partial polynomial output, at 212. For example, referring to FIG. 1, the computation circuitry 116 may add the (a₃) coefficient to the first partial polynomial value to determine the first value 152.

According to one implementation, the method 200 may include retrieving, at the processor, a second instruction for performing a second piecewise Horner's method operation for a second input range of the polynomial. For example, the processor 104 may retrieve the second instruction 107 for the memory 102. The method 200 may also include executing the second instruction 107. Executing the second instruction 107 may include accessing the one or more look-up tables 140 based on the interval of the first function input to determine a second coefficient (e.g., the (a₂) coefficient) of the polynomial (e.g., the piecewise polynomial 132) for the first input range 122. Executing the second instruction 107 may also include determining a second partial polynomial output (e.g., the second value 154) of the second operation for the first input range 122. Determining a second partial polynomial output (e.g., the second value 154) may include multiplying a second partial polynomial input with the first function input to generate a second partial value. The method 200 may also include adding the second coefficient to the second partial value to determine the second partial polynomial output (e.g., the second value 154).

According to one implementation, the method 200 may include evaluating a piecewise polynomial based at least on the first value 152. The method 200 may also include estimating a nonlinear function based on the piecewise polynomial. According to one implementation, a size of the first input range 122 may be different than a size of the second input range 124. According to one implementation of the method 200, the first coefficient (e.g., the (a₀) coefficient) may have a different precision than the second coefficient (e.g., the (a₁) coefficient), and the first partial polynomial input may have a different precision than the second partial polynomial input.

According to one implementation, the method 200 may include normalizing the first input range 122 to a particular range and de-normalizing an output based on the first input range 122. The method 200 may also include combining the polynomial with a second polynomial to generate a multiple orthogonal input function.

According to one implementation of the method 200, the first coefficient, the first value, the first partial value, and the first function input may be fixed-point operands. The fixed-point operands may be signed or unsigned. One or more of the operands may have a different precision than the other operands.

According to one implementation of the method 200, the first coefficient, the first value, the first partial value, and the first function input may be floating-point operands. The floating-point operands may have an Institute of Electrical and Electronics Engineers (IEEE) format. One or more of the operands may have a different precision than the other operands.

In other implementations, at least one of the first coefficient, the first value, the first partial value, and the first function input may be a complex-number operand. In yet another implementation, the first coefficient, the first value, the first partial value, and the first function input may be multi-dimensional operands.

The method 200 of FIG. 2 may reduce the number of table entries used to evaluate a nonlinear function (e.g., the nonlinear function 121) compared to a conventional look-up method by using the piecewise polynomial instruction 106. For example, the processor 104 may access the look-up tables 140 to determine values for each coefficient (a₀-aₙ) as opposed to accessing a look-up table of the entire nonlinear function 121. As a result, the number of table entries used to represent the nonlinear function 121 may be reduced to a product of the number of coefficients present in the piecewise polynomial 132 and the number of input ranges (as opposed to a conventional technique where the number of table entries used by the processor may be exponentially relative to the bit accuracy of the evaluated function).

Additionally, the number of processing stages may be reduced compared to a conventional technique of applying a polynomial over an input range. For example, using piecewise polynomials enables accurate approximation in each input range using fewer coefficients than obtaining the same accuracy over all input ranges using a single (non-piecewise) polynomial to approximate the nonlinear function 121. Additional processing savings may be achieved using Horner's method operation to reduce a number of multiplication operations that are performed during evaluation of the polynomial. Additionally, in some implementations, the look-up process may occur in parallel with the multiplication process (e.g., the computation operations associated with the computation circuitry 116) to reduce processing time. According to another implementation, the input bits used for the table look-up may be removed from the multiplication to achieve greater input precision for a particular multiplier size. The reduction in processing stages may result in reduced power consumption and reduced complexity.

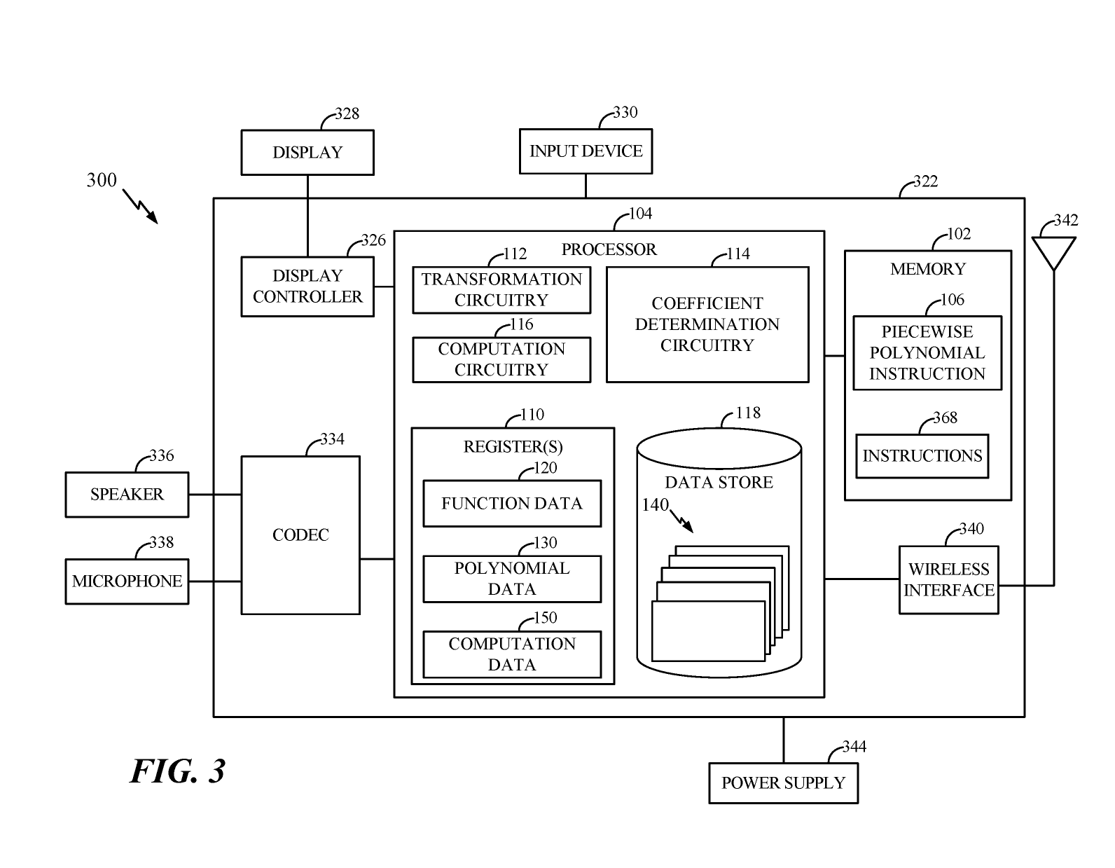

Referring to FIG. 3, a block diagram of an electronic device 300 is shown. The electronic device 300 may correspond to a mobile device (e.g., a cellular telephone), as an illustrative example. In other implementations, the electronic device 300 may correspond to a computer (e.g., a server, a laptop computer, a tablet computer, or a desktop computer), a wearable electronic device (e.g., a personal camera, a head-mounted display, or a watch), a vehicle control system or console, a home appliance, a set top box, an entertainment unit, a navigation device, a personal digital assistant (PDA), a television, a monitor, a tuner, a radio (e.g., a satellite radio), a music player (e.g., a digital music player or a portable music player), a video player (e.g., a digital video player, such as a digital video disc (DVD) player or a portable digital video player), a robot, a healthcare device, another electronic device, or a combination thereof.

The electronic device 300 includes the processor 104, such as a digital signal processor (DSP), a central processing unit (CPU), a graphics processing unit (GPU), another processing device, or a combination thereof. The processor 104 includes the one or more registers 110, the transformation circuitry 112, the coefficient determination circuitry 114, the computation circuitry 116, and the data store 118. The one or more registers 110 store the function data 120, the polynomial data 130, and the computation data 150. The data store 118 stores the one or more look-up tables 140. The processor 104 may operate in a substantially similar manner as described with respect to FIG. 1.

The electronic device 300 may further include the memory 102. The memory 102 may be coupled to or integrated within the processor 104. The memory 102 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another storage device, or a combination thereof. The memory 102 may store the first instruction 106 and one or more other instructions 368 executable by the processor 310. For example, the processor 104 may execute the first instruction 106 to evaluate a nonlinear function, as described with respect to FIG. 1.

FIG. 3 also shows a display controller 326 that is coupled to the processor 104 and to a display 328. A coder/decoder (CODEC) 334 can also be coupled to the processor 104. A speaker 336 and a microphone 338 can be coupled to the CODEC 334. FIG. 3 also indicates that a wireless interface 340, such as a wireless controller and/or a transceiver, can be coupled to the processor 104 and to an antenna 342.

In a particular example, the processor 104, the display controller 326, the memory 102, the CODEC 334, and the wireless interface 340 are included in a system-in-package or system-on-chip device 322. Further, an input device 330 and a power supply 344 may be coupled to the system-on-chip device 322. Moreover, in a particular example, as illustrated in FIG. 3, the display 328, the input device 330, the speaker 336, the microphone 338, the antenna 342, and the power supply 344 are external to the system-on-chip device 322. However, each of the display 328, the input device 330, the speaker 336, the microphone 338, the antenna 342, and the power supply 344 can be coupled to a component of the system-on-chip device 322, such as to an interface or to a controller.

In connection with the disclosed examples, a computer-readable medium (e.g., the memory 102) stores a first instruction that is executable by a processor (e.g., the processor 104) to perform a first piecewise Homer's method operation for a first input range of a polynomial. For example, the first instruction may cause the processor 104 to access one or more look-up tables based on one or more bits of the first input range to determine a first coefficient of the polynomial for the first input range. The first instruction may also cause the processor to determine a first value of the polynomial for the first input range. Determining the first value may include multiplying a first partial input of the polynomial with a first function input associated with the first input range to generate a first partial value and adding the first coefficient to the first partial value to determine the first value.

In conjunction with the described techniques, an apparatus includes means for storing a first instruction for performing a first piecewise Homer's method operation for a first input range of a polynomial. For example, the means for storing the first instruction may include the memory 102 of FIGS. 1 and 3, one or more other devices, circuits, modules, or any combination thereof.

The apparatus may also include means for storing one or more look-up tables. The one or more look-up tables may include coefficient values for the polynomial. For example, the means for storing the one or more look-up tables may include the data store 118 of FIGS. 1 and 3, one or more registers 110 of FIGS. 1 and 3, the processor 104 of FIGS. 1 and 3, one or more other devices, circuits, modules, or any combination thereof.

The apparatus may also include means for accessing the one or more look-up tables based on an interval of a first function input corresponding to a first input range to determine a first coefficient of the polynomial for the first input range. For example, the means for accessing may include the coefficient determination circuitry 114 of FIGS. 1 and 3, the processor 104 of FIGS. 1 and 3, one or more other devices, circuits, modules, or any combination thereof.

The apparatus may also include means for multiplying a first partial polynomial input with the first function input to generate a first partial value. For example, the means for multiplying may include the computation circuitry 116 of FIGS. 1 and 3, the processor 104 of FIGS. 1 and 3, one or more other devices, circuits, modules, or any combination thereof.

The apparatus may also include means for adding the first coefficient to the first partial value to determine a first partial polynomial output of the first piecewise Homer's method operation. For example, the means for adding may include the computation circuitry 116 of FIGS. 1 and 3, the processor 104 of FIGS. 1 and 3, one or more other devices, circuits, modules, or any combination thereof.

The foregoing disclosed devices and functionalities may be designed and represented using computer files (e.g. RTL, GDSII, GERBER, etc.). The computer files may be stored on computer-readable media. Some or all such files may be provided to fabrication handlers who fabricate devices based on such files. Resulting products include wafers that are then cut into die and packaged into integrated circuits (or “chips”). The chips are then employed in electronic devices, such as the electronic device 300 of FIG. 3.

Those of skill would further appreciate that the various illustrative logical blocks, configurations, modules, circuits, and algorithm steps described in connection with the implementations disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method comprising:
retrieving, at a processor, a first instruction for performing a first piecewise Homer's method operation for a polynomial; and
executing the first instruction, wherein executing the first instruction causes the processor to perform operations comprising:
accessing one or more look-up tables based on an interval of a first function input corresponding to a first input range to determine a first coefficient of the polynomial for the first input range; and
determining a first partial polynomial output of the first piecewise Homer's method operation for the first input range, wherein determining the first partial polynomial output comprises:
multiplying a first partial polynomial input with the first function input to generate a first partial value; and
adding the first coefficient to the first partial value to determine the first partial polynomial output.

2. The method of claim 1, wherein the processor includes a single-instruction-multiple-data (SIMD) processor.

3. The method of claim 1, wherein the first input range has a fixed power-of-two size, and wherein the interval is based on one or more most significant bits of the first function input.

4. The method of claim 1, wherein the first input range has an exponential size, and wherein the interval is determined at least partially based on a logarithm of the first function input.

5. The method of claim 1, wherein the first function input is normalized to the first input range.

6. The method of claim 1, further comprising:
retrieving, at the processor, a second instruction for performing a second piecewise Homer's method operation for the polynomial; and
executing the second instruction, wherein executing the second instruction causes the processor to perform operations comprising:
accessing the one or more look-up tables based on the interval of the first function input to determine a second coefficient of the polynomial for the first input range; and
determining a second partial polynomial output of the second operation, wherein determining the second partial polynomial output comprises:
multiplying a second partial polynomial input with the first function input to generate a second partial value, wherein the second partial polynomial input corresponds to the first partial polynomial output; and
adding the second coefficient to the second partial value to determine the second partial polynomial output.

7. The method of claim 6, wherein the first coefficient has a different precision than the second coefficient, or wherein the first partial polynomial input has a different precision than the second partial polynomial input.

8. The method of claim 6, wherein the one or more look-up tables store coefficient values corresponding to multiple sets of input intervals, and wherein each of the multiple sets of input intervals corresponds to a respective order of a piecewise polynomial.

9. The method of claim 8, wherein a size of the first input range is different than a size of a second input range.

10. The method of claim 1, further comprising evaluating a piecewise polynomial based at least on the first partial polynomial output.

11. The method of claim 10, further comprising estimating a nonlinear function based on the piecewise polynomial.

12. The method of claim 1, further comprising:
normalizing a first input to a particular range; and
de-normalizing an output based on the particular range.

13. The method of claim 1, wherein the first coefficient, the first partial polynomial output, the first partial value, or the first function input are fixed-point operands.

14. The method of claim 13, wherein at least one of the fixed-point operands are signed.

15. The method of claim 13, wherein at least one of the fixed-point operands are unsigned.

16. The method of claim 13, wherein the first coefficient has a different precision than the first partial polynomial output.

17. The method of claim 1, wherein the first coefficient, the first partial polynomial output, the first partial value, or the first input range are floating-point operands.

18. The method of claim 17, wherein the first coefficient has a different precision than the first partial polynomial output.

19. The method of claim 1, wherein at least one of the first coefficient, the first partial polynomial output, the first partial value, and the first function input is a complex-number operand.

20. An apparatus comprising:
a memory storing a first instruction for performing a first piecewise Horner's method operation for a polynomial;
a data store storing one or more look-up tables, the one or more look-up tables including coefficient values for the polynomial at multiple input ranges;
coefficient determination circuitry configured to access the one or more look-up tables based on an interval of a first function input corresponding to a first input range to determine a first coefficient of the polynomial for the first input range; and
computation circuitry configured to:
multiply a first partial polynomial input with the first function input to generate a first partial value; and
add the first coefficient to the first partial value to determine a first partial polynomial output of the first piecewise Horner's method operation for the first input range.

21. The apparatus of claim 20, wherein the computation circuitry is integrated into a single-instruction-multiple-data (SIMD) processor.

22. The apparatus of claim 20, wherein the first input range has a fixed power-of-two size, and wherein the one or more bits of the first function input include one or more most significant bits of the first function input.

23. The apparatus of claim 20, wherein the first input range has an exponential size, and wherein the interval is determined at least partially based on a logarithm of the first function input.

24. A non-transitory computer-readable medium comprising a first instruction for performing a first piecewise Homer's method operation for a polynomial, the first instruction, when executed by a processor, causes the processor to perform operations comprising:
accessing one or more look-up tables based on an interval of a first function input corresponding to a first input range to determine a first coefficient of the polynomial for the first input range; and
determining a first partial polynomial output of the first piecewise Homer's method operation for the first input range, wherein determining the first partial polynomial output comprises:
multiplying a first partial polynomial input with the first function input to generate a first partial value; and
adding the first coefficient to the first partial value to determine the first partial polynomial output.

25. The non-transitory computer-readable medium of claim 24, wherein the processor includes a single-instruction-multiple-data (SIMD) processor.

26. An apparatus comprising:
means for storing a first instruction for performing a first piecewise Homer's method operation for a polynomial;
means for storing one or more look-up tables, the one or more look-up tables including coefficient values for the polynomial;
means for accessing the one or more look-up tables based on an interval of a first function input corresponding to a first input range to determine a first coefficient of the polynomial for the first input range;
means for multiplying a first partial polynomial input with the first function input to generate a first partial value; and
means for adding the first coefficient to the first partial value to determine a first partial polynomial output of the first piecewise Homer's method operation.

27. The apparatus of claim 26, wherein the first input range has a fixed power-of-two size, and wherein the one or more bits of the first function input include one or more most significant bits of the first function input.
